(19) United States
(12) Patent Application Publication
(10) Pub. No.: US 2010/0001094 A1
(43) Pub. Date: Jan. 7, 2010

(54) APPARATUS AND METHOD FOR COOLING A FUEL INJECTOR INCLUDING A PIEZOELECTRIC ELEMENT

(75) Inventors: Jay Venkataraghavan, Dunlap, IL (US); Stephen R. Lewis, Chillicothe, IL (US); Amy M. Hess, Metamora, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 12/167,273

(22) Filed: Jul. 3, 2008

(51) Int. Cl. F02M 51/06

(52) U.S. Cl. 239/102.2; 123/472

(57) ABSTRACT

A fuel injector including a nozzle portion and an electrically actuated valve assembly configured to control a flow of fuel to the nozzle portion. The electrically actuated valve assembly may include a piezoelectric element and a biasing member. The fuel injector also may include a housing with at least a portion of the electrically actuated valve assembly disposed in the housing. The housing may define a cavity between the piezoelectric element and the housing. A thermally conductive material may be disposed at least partially within the cavity and may be configured to transfer heat from the piezoelectric element to the housing.

### TECHNICAL FIELD

The present disclosure relates to a fuel injector, and, more particularly, to an apparatus and method for cooling a fuel injector including a piezoelectric element.

### BACKGROUND

Some engines use fuel injection systems to introduce fuel into the combustion chambers of the engine. The fuel injection system may be any one of various types of fuel systems and may include, within the system, a number of fuel injectors. Among the various valves controlling the flow of fuel, a fuel injector may include at least one piezoelectric actuator for controlling operation of the valve assembly. Moreover, the fuel injector may include a piezoelectric actuator that facilitates intensification of fuel pressure within the fuel injection system.

A piezoelectric actuator typically consists of a piezoelectric element that is capable of changing conformation, such as by lengthening in response to application of an electrical potential. In operation, the piezoelectric element lengthens and shortens relatively rapidly to control the position of a control valve or a piston, for example. The relatively rapid and repeated actuation of the piezoelectric element tends to generate a relatively large amount of heat, which when coupled with heat generated by the engine, may raise the temperature of the piezoelectric element and associated components above desired levels. In some instances, without a mechanism for cooling engine system components, in particular, fuel injector components, operation of the fuel system and associated engine may be sub-optimal, or even compromised altogether.

U.S. Pat. No. 4,553,059 to Abe et al. (“the '059 patent”) is directed to a cooling system for a piezoelectric actuator. The '059 patent discloses a piezoelectric actuator including a housing wherein a piezoelectric element is disposed. The piezoelectric element is positioned within an enclosure and the enclosure houses a thermally conductive oil. A cooling fluid is circulated through a space surrounding the enclosure. The cooling liquid absorbs heat from the piezoelectric element.

While the '059 patent provides a cooling system for a piezoelectric actuator used in a fuel injector, several disadvantages are apparent with the disclosed system. For example, the fluid connections necessary to supply and drain the cooling fluid are relatively complex. Moreover, assembly and proper positioning of the piezoelectric actuator may be cumbersome in an engine environment. Furthermore, because the oil is in contact with the piezoelectric element, i.e., the oil contacts the individual disks forming the piezoelectric element, the operation of the piezoelectric element may be hindered and/or compromised. The thermally conductive oil may also leak into other areas of the fuel injector, thereby contaminating the fuel injector, potentially damaging various parts therein, and potentially mixing with the fuel contained in the fuel injector.

The disclosed apparatus and method for cooling a fuel injector including a piezoelectric element is directed to improvements in the existing technology.

### SUMMARY

In one aspect, the present disclosure is directed toward a fuel injector including a nozzle portion; an electrically actuated valve assembly configured to control a flow of fuel to the nozzle portion, the electrically actuated valve assembly including a piezoelectric element and a biasing member; a housing, at least a portion of the electrically actuated valve assembly disposed in the housing, the housing defining a cavity between the piezoelectric element and the housing; and a thermally conductive material disposed at least partially within the cavity, the thermally conductive material configured to transfer heat from the piezoelectric element to the housing.

In another aspect, the present disclosure is directed toward a method for transferring heat from a piezoelectric element of an electrically actuated valve assembly, the method including the steps of providing a fuel injector including a housing and an electrically actuated valve assembly having a piezoelectric element and a biasing member; positioning at least a portion of the electrically actuated valve assembly within the housing to define a cavity between the piezoelectric element and the housing; and at least partially filling the housing with a thermally conductive material, the thermally conductive material configured to transfer heat from the piezoelectric element to the housing.

In yet another aspect, the present disclosure is directed toward a machine including an engine configured to generate a power output and including at least one combustion chamber; and a fuel injector configured to inject fuel into the at least one combustion chamber, the fuel injector including a nozzle portion; an electrically actuated valve assembly configured to control a flow of fuel to the nozzle portion, the electrically actuated valve assembly including a piezoelectric element and a biasing member; a housing, at least a portion of the electrically actuated valve assembly disposed in the housing, the housing defining a cavity between the piezoelectric element and the housing; and a thermally conductive material disposed at least partially within the cavity, the thermally conductive material configured to transfer heat from the piezoelectric element to the housing.

### BRIEF DESCRIPTION OF THE DRAWINGS

FIG. 1 is a diagrammatic view of an engine including a fuel injection system incorporating a plurality of fuel injectors each having at least one piezoelectric actuator; and

FIG. 2 is a cross-sectional view of a portion of a fuel injector of FIG. 1, further illustrating the piezoelectric actuator of the fuel injector.

### DETAILED DESCRIPTION

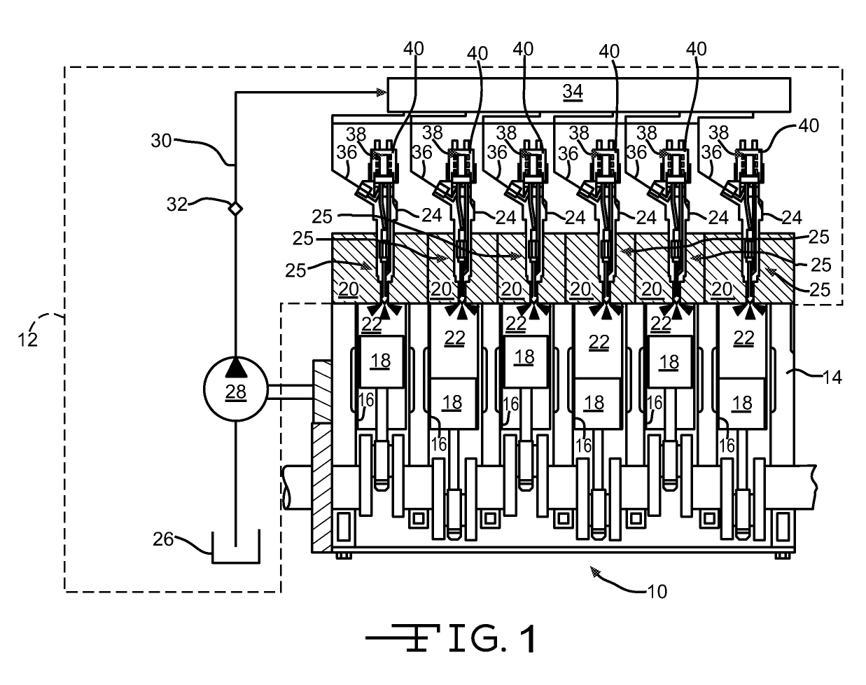

FIG. 1 diagrammatically illustrates an engine 10 with a fuel injection system 12. Engine 10 includes an engine block 14 that defines a plurality of cylinders 16, a piston 18 slidably disposed within each cylinder 16, and a cylinder head 20 associated with each cylinder 16. The cylinder 16, the piston 18, and the cylinder head 20 form a combustion chamber 22. The fuel injection system 12 includes components that cooperate to deliver fuel to fuel injectors 24, which in turn deliver fuel into each combustion chamber 22. Specifically, the fuel injection system 12 includes a supply tank 26, a fuel pump 28, a fuel line 30 with a check valve 32, and a manifold or fuel rail 34. From the fuel rail 34, fuel is supplied to each fuel injector 24 through a fuel line 36. As shown, each fuel injector 24 includes one or more piezoelectric actuated valve assemblies 38 and a fuel injector nozzle portion 25. Each piezoelectric actuated valve assembly 38 may include an associated piezoelectric element 40 for controlling a valve element 42 to control the flow of fuel to the fuel injector nozzle portion 25 to inject fuel into the combustion chambers 22. The piezoelectric element 40 of the valve assembly 38 may generate heat as the element 40 cycles between an activated, or energized, state and a deactivated, or de-energized, state.

In one embodiment, engine 10 may be a direct injection compression ignition diesel engine, however, in other embodiments, engine 10 may be a spark-ignited engine, a port injected engine, or any of a variety of other engine configurations. Fuel injectors 24 may be identical to one another, and thus references herein to a single fuel injector 24 or a single associated component should be understood to similarly refer to corresponding components and operation of the other fuel injectors 24. As further explained herein, engine 10 includes a cooling strategy for the components of fuel injectors 24 whereby heat may be dissipated from the corresponding valve assembly 38.

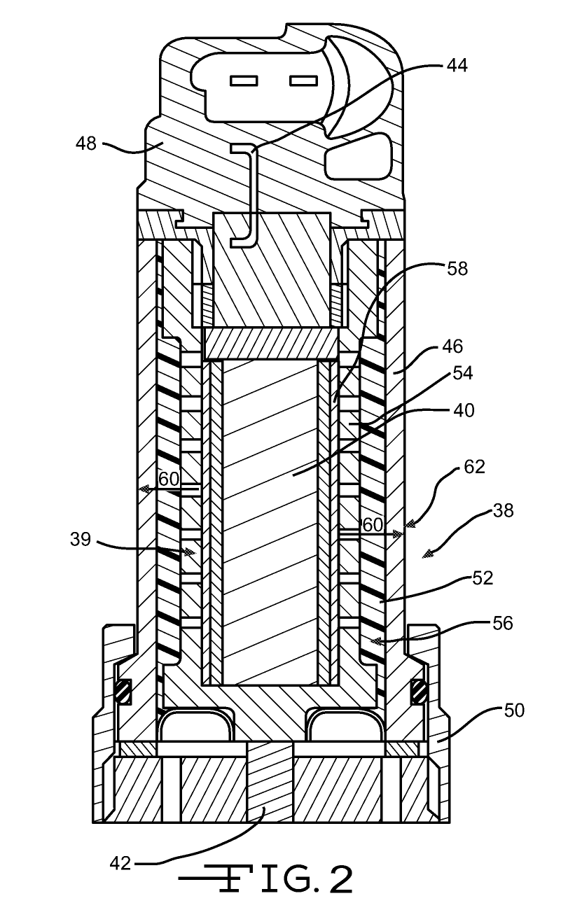

Referring to FIG. 2, in one embodiment, the piezoelectric actuated valve assembly 38 includes a piezoelectric actuator 39 having the piezoelectric element 40 fluidly sealed within a casing or housing 46 and configured to connect with an electrical system (not shown) of an associated engine system via at least one electrical connector 44. Electrical connector 44 may be accessible via a cap 48 of valve assembly 38. Casing 46 may be coupled with and fluidly sealed with fuel injector body 50. Casing 46 may include a plurality of internal components fluidly sealed within casing 46, and fluidly isolated from other components of fuel injector 24. The piezoelectric actuator 39 may include the piezoelectric element 40, such as a stack of piezoelectric disks, and a thermally conductive material 52 that is in thermal contact with the piezoelectric element 40. In an exemplary embodiment, the thermally conductive material 52 is not in direct contact with the piezoelectric disks which form the piezoelectric element 40, but instead the thermally conductive material 52 is in direct contact with a barrier or wall 58 which protects the piezoelectric element 40 from contamination via the thermally conductive material 52, as described further below. The piezoelectric element 40 may be positioned at least partially within a preloading spring or biasing element 54 that is also fluidly sealed within the casing 46. The preloading spring 54 may exert a preloading force, such as a compressive force, on the piezoelectric element 40 to enable desired operation, in a manner familiar to those skilled in the art.

Valve assembly 38 may further define a thermal transfer pathway 60 from the piezoelectric element 40 to casing 46. Thermally conductive material 52 may substantially surround the piezoelectric element 40 and be in thermal contact therewith via the barrier 58. Thermally conductive material 52 may be formed as a thermal transfer material such as thermally conductive silicone gel, including any of a variety of proprietary and/or commercially available materials having a thermal conductivity value of approximately 0.1 W/mK at approximately 25° C. Exemplary materials for the thermally conductive material 52 may include silicone gel products manufactured by Dow Corning® (Dow Corning is a registered trademark of Dow Corning Corporation). A cavity 56 may be defined in part by the barrier 58 and the casing 46. In one embodiment, the thermally conductive material 52 is positioned within cavity 56. The cavity 56 may be fluidly separated from the piezoelectric element 40 via the barrier or wall 58. Barrier 58 may be a housing or casing for the piezoelectric element 40 to protect the individual piezoelectric disks that form the piezoelectric element 40. The cavity 56 may be filled or substantially filled with the thermally conductive material 52, for example by injecting the thermally conductive material 52 therein. In one embodiment, the thermally conductive material 52 is formed initially as a liquid that is poured into cavity 56 after which the thermally conductive material 52 solidifies, and/or is cured, to a gel or semi-solid state, such as a state having a composition similar to rubber, for example. When cavity 56 is filled with the thermally conductive material 52, the valve assembly 38 may be at least substantially free of air, thereby improving thermal transfer between components thereof. Thermal transfer pathway 60 may extend from the barrier 58 or the piezoelectric element 40, through the thermally conductive material 52, and to the casing 46. Moreover, the thermal transfer pathway 60 may also include portions of spring 54, which may also serve to conduct heat from the piezoelectric element 40 to the casing 46. Although illustrated as being generally perpendicular to casing 46, the thermal transfer pathway 60 may extend from the barrier 58 towards the casing 46 in any direction. Thermally conductive material 52 is typically in thermal contact with both the spring 54 and the piezoelectric element 40, and at least a portion of the thermally conductive material 52 may typically be between the spring 54 and the barrier 58.

In one embodiment, a portion of each casing 46 extends from each cylinder head 20, e.g., the valve assembly 38 may be positioned such that the casing 46 extends upwardly from the cylinder head 20 when mounted therein. This allows at least a portion of casing 46, for example 40% or more of an exterior of casing 46, to be exposed to a space defined by the cylinder head 20 and a valve cover (not shown). This can enhance the cooling efficacy, as casing 46 may radiate heat into the space defined by the valve cover and the cylinder head 20, and/or oil splash on casing 46 may also conduct heat therefrom.

Referring still to FIG. 2, the casing 46, the thermally conductive material 52, the barrier 58, and, optionally, the spring 54, together define a heat transfer assembly 62. The thermally conductive material 52 provides a convenient and efficient way to absorb and dissipate excess heat generated within the casing 46, such as the heat generated by the associated piezoelectric element 40 and by fuel within the fuel injector 24 proximate the valve assembly 38, thereby effectively cooling the fuel injector 24 associated with the valve assembly 38. The thermally conductive material 52 functions by efficiently transferring thermal energy, e.g., heat, from a first object, e.g., the piezoelectric element 40, at a relatively high temperature, to a second object, e.g., casing 46, at a relatively lower temperature with a much greater heat capacity. The transfer of thermal energy brings the piezoelectric element 40 into thermal equilibrium with the casing 46, thereby lowering the temperature of the piezoelectric element 40 and effectively cooling the fuel injector 24 associated with the piezoelectric element 40. The casing 46 in turn dissipates the heat to the surrounding ambient air and/or to other components of the engine 10 (FIG. 1).

The consistency of the thermally conductive material 52 is such as to not interfere with operation of the spring 54. Moreover, barrier 58 prevents the thermally conductive material 52 from hindering actuation of the piezoelectric element 40 and from potential damage due to the interaction of the material of the piezoelectric element 40 and the thermally conductive material 52. The thermally conductive material 52 also provides a dampening effect for the valve assembly 38 such that the thermally conductive material 52 dampens any vibrations that the valve assembly 38 may be subjected to during operation of the fuel injector 24. Furthermore, the thermally conductive material 52 is not susceptible to leak to other portions of the fuel injector because of the semi-solid or gel-like consistency of the material.

### INDUSTRIAL APPLICABILITY

The disclosed apparatus and method for cooling a fuel injector may be applicable to any engine utilizing a piezoelectric actuator, such as actuators used in many types of fuel injectors.

In operation and referring to FIGS. 1 and 2, the engine 10 is started and the fuel pump 28 may receive fuel from the fuel tank 26 and subsequently supply fuel at a relatively high pressure to rail 34. Each fuel injector 24 is connected with rail 34 and may receive high pressure fuel therefrom in a conventional manner. Valve assemblies 38 may be used to selectively open nozzle outlets of the corresponding fuel injectors 24 to inject fuel into the corresponding cylinders 16. As described above, operation of the actuators 39 associated with each valve assembly 38 may generate heat.

The thermally conductive material 52 may provide an effective cooling mechanism to draw heat from the piezoelectric element 40 associated with a fuel injector 24. The heat absorbed by the thermally conductive material 52 through barrier 58 may then be transferred to the casing 46, after which the heat may be transferred to the surrounding air or other components of the engine 10. The thermally conductive material 52 may be formed of a material which has a relatively greater thermal conductivity value than the material forming the piezoelectric element 40 such that heat is absorbed from the piezoelectric element 40, thereby reducing the temperature of the piezoelectric element 40 and cooling the associated fuel injector 24.

It will be apparent to those skilled in the art that various modifications and variations can be made to the disclosed cooling apparatus and method without departing from the scope of the disclosure. Other embodiments of the cooling apparatus and method will be apparent to those skilled in the art from consideration of the specification and practice of the embodiments disclosed herein. For example, while the present description focuses primarily on cooling piezoelectric actuators, it is not limited thereto. In other embodiments, solenoid actuators, or other electrical or even mechanical actuators could be successfully cooled according to the teachings of the present disclosure. Moreover, while common rail systems will often be used in engines contemplated herein, the present disclosure is also not limited in this regard. Unit pumps associated with each of a plurality of fuel injectors, such as cam actuated pumps, might also be used, and the presently described cooling apparatus and method may be used to cool electrical actuators associated with cam actuated fuel injectors. It is intended that the specification and examples be considered as exemplary only, with a true scope of the disclosure being indicated by the following claims and their equivalents.

What is claimed is:

1. A fuel injector, comprising:
a nozzle portion;
an electrically actuated valve assembly configured to control a flow of fuel to the nozzle portion, the electrically actuated valve assembly including a piezoelectric element and a biasing member;
a housing, at least a portion of the electrically actuated valve assembly disposed in the housing, the housing defining a cavity between the piezoelectric element and the housing; and
a thermally conductive material disposed at least partially within the cavity, the thermally conductive material configured to transfer heat from the piezoelectric element to the housing.

2. The fuel injector of claim 1, wherein the biasing member is disposed at least partially within the cavity.

3. The fuel injector of claim 1, wherein the electrically actuated valve assembly further includes a piezoelectric element casing, the piezoelectric element disposed within the piezoelectric element casing and the biasing member disposed outside of the piezoelectric element casing.

4. The fuel injector of claim 3, wherein the cavity is defined between the piezoelectric element casing and the housing.

5. The fuel injector of claim 4, wherein the biasing member is at least partially disposed within the thermally conductive material.

6. The fuel injector of claim 1, wherein the thermally conductive material is formed of a first material having a first thermal conductivity value, and the piezoelectric element is formed of a second material having a second thermal conductivity value, the first thermal conductivity value being greater than the second thermal conductivity value.

7. The fuel injector of claim 1, wherein the biasing member is at least partially disposed within the thermally conductive material.

8. The fuel injector of claim 1, wherein the thermally conductive material dampens a vibration force experienced by the fuel injector.

9. A method for transferring heat from a piezoelectric element of an electrically actuated valve assembly, the method comprising the steps of:
providing a fuel injector including a housing and an electrically actuated valve assembly having a piezoelectric element and a biasing member;
positioning at least a portion of the electrically actuated valve assembly within the housing to define a cavity between the piezoelectric element and the housing; and
at least partially filling the housing with a thermally conductive material, the thermally conductive material configured to transfer heat from the piezoelectric element to the housing.

10. The method of claim 9, wherein the thermally conductive material is further configured to dampen a vibration experienced by the electrically actuated valve assembly.

11. The method of claim 9, further including the step of positioning the biasing member at least partially within the cavity.

12. The method of claim 9, further including the step of positioning the biasing member at least partially within the thermally conductive material.

13. The method of claim 9, wherein the electrically actuated valve assembly includes a piezoelectric element casing, and the method further including the steps of positioning the piezoelectric element within the piezoelectric element casing, and positioning the biasing member outside of the piezoelectric element casing, wherein the cavity is defined between the piezoelectric element casing and the housing.

14. A machine, comprising:
an engine configured to generate a power output and including at least one combustion chamber; and
a fuel injector configured to inject fuel into the at least one combustion chamber, the fuel injector including:
a nozzle portion;
an electrically actuated valve assembly configured to control a flow of fuel to the nozzle portion, the electrically actuated valve assembly including a piezoelectric element and a biasing member;
a housing, at least a portion of the electrically actuated valve assembly disposed in the housing, the housing defining a cavity between the piezoelectric element and the housing; and
a thermally conductive material disposed at least partially within the cavity, the thermally conductive material configured to transfer heat from the piezoelectric element to the housing.

15. The machine of claim 14, wherein the biasing member is disposed at least partially within the cavity.

16. The machine of claim 14, wherein the electrically actuated valve assembly further includes a piezoelectric element casing, the piezoelectric element disposed within the piezoelectric element casing and the biasing member disposed outside of the piezoelectric element casing.

17. The machine of claim 16, wherein the cavity is defined between the piezoelectric element casing and the housing.

18. The machine of claim 17, wherein the biasing member is at least partially disposed within the thermally conductive material.

19. The machine of claim 14, wherein the thermally conductive material is formed of a silicone gel material.

20. The machine of claim 14, wherein the biasing member is at least partially disposed within the thermally conductive material.
